(19) United States
(12) Patent Application Publication
(10) Pub. No.: US 2014/0047003 A1
(43) Pub. Date: Feb. 13, 2014

(54) PROCESSING DATA ENTITIES ASSOCIATED TO DESCRIPTORS

(71) Applicants: Boris Golden, Le-Perreux-sur-Marne (FR); Yann Hourdel, Paris (FR); Anthony Simon, Paris (FR)

(72) Inventors: Boris Golden, Le-Perreux-sur-Marne (FR); Yann Hourdel, Paris (FR); Anthony Simon, Paris (FR)

(21) Appl. No.: 13/572,874

(22) Filed: Aug. 13, 2012

(51) Int. Cl. G06F 15/16

(52) U.S. Cl. 709/203

(57) ABSTRACT

It is provided a method, implemented with a client computer system connected to a server and having a processor coupled to a memory and a graphical user interface, the method being for processing a dataset of data entities stored on the server and each associated to a set of descriptors. The method comprises sending, to the server, a search query inputted with the graphical user interface, receiving on the memory of the client computer system, from the server, a list of data entities of the dataset respecting the search query, displaying (S30) a data entity of the received list of data entities, and loading the set of descriptors associated to the displayed data entity, and, for each of a subset of a predetermined number of consecutive data entities of the received list of data entities surrounding the displayed data entity, pre-loading the associated set of descriptors.

### TECHNICAL FIELD OF THE INVENTION

The present invention pertains to the field of computer science. More particularly, it relates to a method, a client computer system, and a computer program product for processing a dataset of data entities stored on a server and each associated to a set of descriptors.

### BACKGROUND ART

Many solutions for processing data stored on a server are known from the field of computer science. Examples include search engines for processing people profiles stored on a server. In such examples, a user using a client computer system may input a search query, send said search query to the server, which in turn returns a list of all the people profiles contained in the database that respect the query. Usually, a part of the list is displayed as previews (e.g. the first twenty results), and the user can either move to other parts (e.g. the next groups of twenty results), or trigger the display of an extended view of one of the data entity (e.g. by clicking on its preview). This technique is however not optimal from a user point of view, notably because the only contemplated data are the data entities.

### SUMMARY OF THE INVENTION

The present invention thus aims at improving the processing of data stored on a server.

According to one aspect, the invention provides a method implemented with a client computer system. The client computer system is connected to a server. The client computer system has a processor coupled to a memory and a graphical user interface. The method is for processing a dataset of data entities stored on the server. Each of the data entities is associated to a set of descriptors. The method comprises sending, to the server, a search query inputted with the graphical user interface. The method also comprises receiving on a memory of the client computer system, from the server, a list of data entities of the dataset respecting the search query. The method also comprises displaying a data entity of the received list of data entities, and loading the set of descriptors associated to the displayed data entity. And the method comprises, for each data entity of a subset of consecutive data entities of the received list of data entities surrounding the displayed data entity, pre-loading the associated set of descriptors.

According to another aspect, the invention provides a client computer system. The client computer system comprises a memory, a graphical user interface, and a processor coupled to the memory and the graphical interface. The processor is operable to implement instructions recorded on another memory for performing a method for processing a dataset of data entities stored on a server and each associated to a set of descriptors. The method comprises sending, to the server, a search query inputted with the graphical user interface. The method also comprises receiving on the memory of the client computer system, from the server, a list of data entities of the dataset respecting the search query. The method also comprises displaying a data entity of the received list of data entities, and loading the set of descriptors associated to the displayed data entity. The method also comprises, for each data entity of a subset of consecutive data entities of the received list of data entities surrounding the displayed data entity, pre-loading the associated set of descriptors.

According to another aspect, the invention provides a computer program product. The computer program product comprises instructions implementable by a client computer system. The client computer system may be connected to a server and has a processor coupled to a memory and a graphical user interface. The instructions are for implementing a method for processing a dataset of data entities stored on a server and each associated to a set of descriptors. The method comprises sending, to the server, a search query inputted with the graphical user interface. The method also comprises receiving on a memory of the client computer system, from the server, a list of data entities of the dataset respecting the search query. The method also comprises displaying a data entity of the received list of data entities, and loading the set of descriptors associated to the displayed data entity. The method also comprises, for each data entity of a subset of consecutive data entities of the received list of data entities surrounding the displayed data entity, pre-loading the associated set of descriptors. The computer program product may further comprise a data storage medium having recorded thereon the instructions. In such a case, the product may consist of said hardware data storage medium having recorded thereon the instructions for performing the method.

### BRIEF DESCRIPTION OF THE DRAWINGS

Other characteristics and advantages of the invention will become apparent on reading the following description of particular embodiments of the invention given by way of non-limiting examples and with references to the accompanying drawings, wherein:

FIG. 1 shows an example of a client computer system,

FIG. 2 shows a flowchart of an example of the method,

FIG. 3 shows an example of a client computer system while performing an example of the method, and

FIGS. 4-7 show examples of application interfaces displayed on the screen of a client computer system while performing examples of the method.

### DETAILED DESCRIPTION OF PREFERRED EMBODIMENTS OF THE INVENTION

The method is implemented with a client computer system. This means that steps of the method are executed by a computer system. Steps of the method are in particular performed by a processor of the system coupled with other hardware pieces of the system. Here, the expression “computer system” designates any system comprising a memory, a graphical user interface, and a processor coupled, e.g. via a communication BUS, to the memory and the graphical interface. The client computer system may be a desktop or a laptop computer, but it may also be a mobile phone or a mobile pad, or any system alike.

By “client” computer system, it is meant that the system is adapted to be connected to a distant server and to receive information from the server, e.g. upon sending requests to the server. In effect, when the method is implemented, the client computer system is actually connected to a server (at least one server). Such connection may be ensured by any adapted communication module, for example comprising a network adapter for managing access to a network, e.g. the internet network.

Steps of the method may be executed via user-interaction. Notably, steps of the method may be triggered, or launched, by a user of the system, who can communicate with the system via a graphical user interface. The graphical user interface may be any combination of hardware and software allowing the user to interact with the system. As known per se, the graphical user interface may comprise a display module, e.g. a screen, to provide representation of information to the user and an input module for giving orders to the system, e.g. including a haptic device such as a mouse with an associated cursor and/or a keyboard, and/or a touchpad and/or a sensitive screen.

The processor of the system is operable to implement instructions recorded on another memory. This other memory can be a compartment of a global memory also comprising the memory of the system used for storing information during implementation of the method. This latter memory is however hereafter referred to as “the memory of the client computer system” for the sake of convenience, whereas the former memory is referred to as “the memory having recorded thereon the instructions”. The memory having recorded thereon the instructions may result from using a computer program product comprising the instructions and installing the instructions on the computer system. Alternatively, the computer program product may further comprise a data storage medium having recorded thereon the instructions, and the data storage medium may thus directly constitute the memory having recorded thereon the instructions, e.g. if inserted in an appropriate slot of the computer system. The global memory may also be memory allocated by the Operating System to a Web browser. This is all known per se from the field of computer science.

The program may for example be implemented in digital electronic circuitry, or in computer hardware, firmware, software, or in combinations of them. Apparatus of the invention may be implemented in a computer program product tangibly embodied in a machine-readable storage device for execution by a programmable processor; and method steps of the invention may be performed by a programmable processor executing a program of instructions to perform functions of the invention by operating on input data and generating output. The instructions may advantageously be implemented in one or more computer programs that are executable on a programmable system including at least one programmable processor coupled to receive data and instructions from, and to transmit data and instructions to, a data storage system, at least one input device, and at least one output device. The application program may be implemented in a high-level procedural or object-oriented programming language, or in assembly or machine language if desired; and in any case, the language may be a compiled or interpreted language. The program may be a full installation program, or an update program.

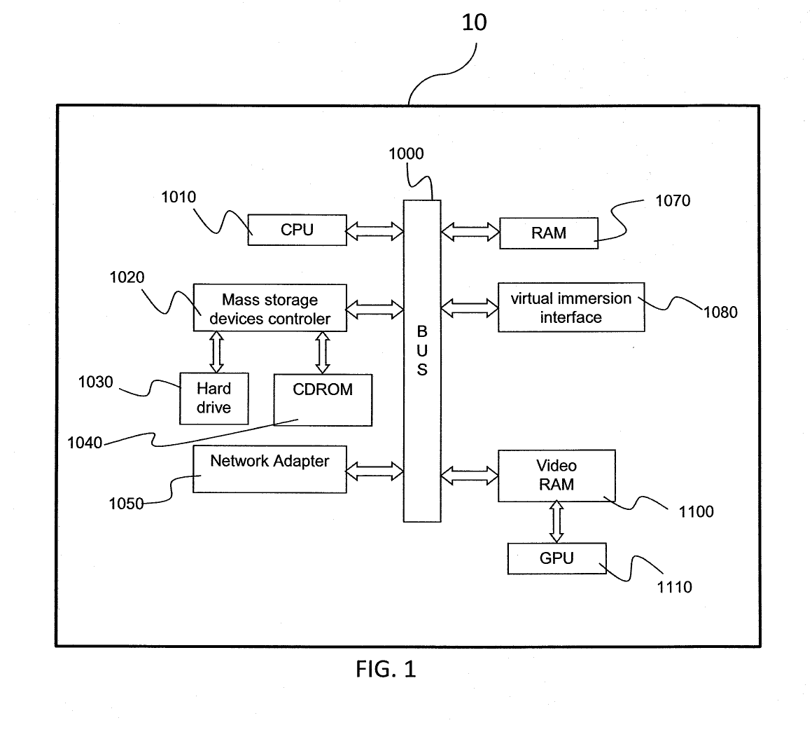

FIG. 1 shows a block diagram of a client computer system 10 suitable for performing the method.

The client computer comprises a central processing unit (CPU) 1010 connected to an internal communication BUS 1000, a random access memory (RAM) 1070 also connected to the BUS. The client computer is further provided with a graphics processing unit (GPU) 1110 which is associated with a video random access memory 1100 connected to the BUS. Video RAM 1100 is also known in the art as frame buffer. A mass storage device controller 1020 manages accesses to a mass memory device, such as hard drive 1030. Mass memory devices suitable for tangibly embodying computer program instructions and data include all forms of nonvolatile memory, including by way of example semiconductor memory devices, such as EPROM, EEPROM, and flash memory devices; magnetic disks such as internal hard disks and removable disks; magneto-optical disks; and CD-ROM disks 1040. Any of the foregoing may be supplemented by, or incorporated in, specially designed ASICs (application-specific integrated circuits). A network adapter 1050 manages accesses to a network, e.g. the internet network, for connecting client system 10 to a distant server.

The method is for processing a dataset of data entities stored on the server to which the client computer system is connected. The dataset may be a part of a larger dataset, of which the other part is stored on one or more other servers to which the client system is also connected. In such a case, the client-server communication steps of the method involve all the servers. However, in the following, mention of only one server is made.

The server stores a set of data entities. A data entity is a set of pieces of data linked together so as to form a unit. The data entities can represent anything, for example product information or drug compositions. In an example, the data entities are people profiles. In other words, the data entities may gather any data describing people. For example, the data entities may gather text containing information on people, including for example a name, a professional resume, an academic background, recommendations made by other people. The data entities may also gather pictures of said people, and/or audio speeches made by said people. Any type of information associated to people may be contemplated within this example.

Each data entity of the data set is associated to a set of descriptors (the set being possibly void for some of the data entities, but non void for at least one data entity). A descriptor is a piece of computer instructions associated to a data entity that additionally characterizes/describes the data entity to which it is associated upon execution. Different examples of descriptors will be provided later. At this point, it is only worth mentioning that the descriptors have to be loaded in order to be executable upon (e.g. single) user action, and that some descriptors are automatically executed as soon as they are loaded. In order to perform the loading, a descriptor may require a pre-loading. The pre-loading comprises gathering the information necessary for loading the descriptor. The loading comprises putting into the main memory of the system all the information necessary to the execution of the descriptor (i.e. simple access and read). This may involve transforming the information gathered during the pre-loading or adding other information to it. This is all known from the field of computer science.

Associating each data entity with a set of descriptors enhances the dataset as it increases the capabilities provided by processing the dataset. By “processing the dataset”, it is meant that the user can manipulate the dataset e.g. in order to analyze it. This may include browsing the data set, performing searches on the dataset, sorting the dataset, extracting data from the dataset, performing statistical analysis on the dataset. All types of data processing that can be performed by the user are contemplated.

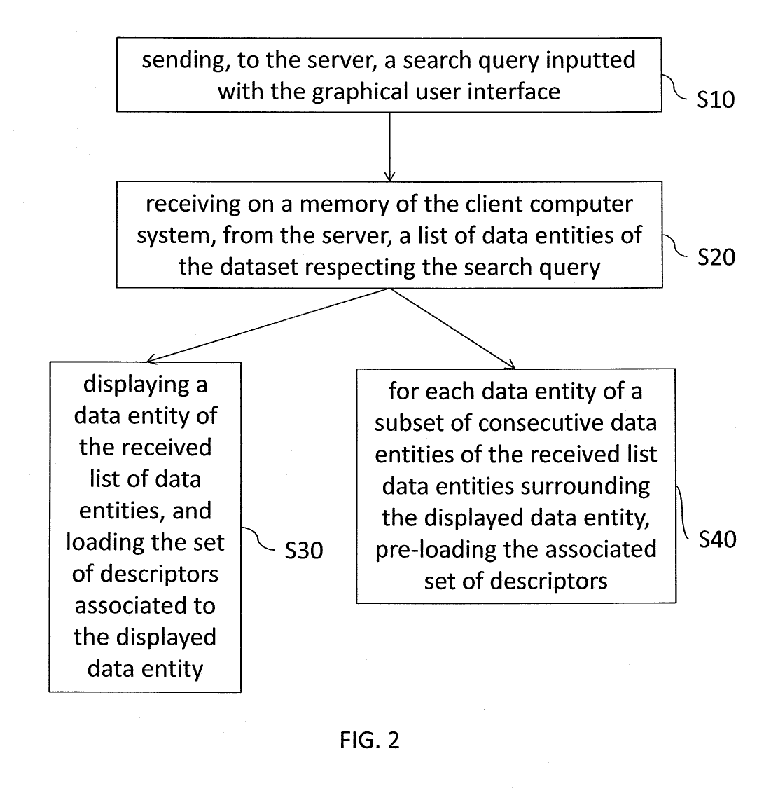

Referring to the flowchart of FIG. 2 that shows a general view of the method performed by the client computer system, the method comprises sending (S10), to the server, a search query inputted with the graphical user interface. In other words, the user may input a search query with the graphical user interface, e.g. by entering a list of keywords in a search bar, and the client computer system may send the search query to the server. The method then comprises receiving (S20) on a memory of the client computer system, from the server, a list of data entities of the dataset respecting the search query. As widely known from the field of search engines, the server may interpret the search query and run a search on the dataset in order to find all the data entities of the dataset that meet/respect the query. The server may return (at least a part of) these search results to the client computer system. In the case of the method, the server sends the data entities under the form of a list (i.e. an ordered set), thus with an order among the returned results. The order may be based on any criterion, such as the alphabetical order of a title of each of the data entities, or significance relative to the search query, or any ranking between the data entities. Notably in order not to saturate the memory of the client computer system and/or for efficiency purposes, the server may return these results in a block-by-block form. In other words, instead of returning the list all the data entities that respect the query, the server may return sub-lists of such data entities, the user having the possibility to move from one sub-list to another. In the following, the expressions “the list” or “the received list” designate any case.

Having received data entities that respect the query, the user may start processing them in any way. Examples of what can be done by the user will be provided later. In any case, at some point (possibly immediately and automatically after the reception S20, but also possibly later on), the method comprises (S30) displaying a (given) data entity of the received list of data entities, and loading the set of descriptors associated to the displayed data entity. This may for example correspond to the user processing one of the received data entities by first visualizing it. Of course, the method may display more than one data entity simultaneously. However, in the following it will be referred to “the displayed data entity” for the sake of convenience, without loss of generality. Displaying the data entity means representing to the user its components. If the data entity contains text, said text may be displayed. If the data entity contains image data, said image data may be displayed. If the data entity contains videos or an audio track, then an icon or a clickable image for launching the video or the audio track may be displayed, or the video may be directly played, or the audio track may be directly played with an indication of such playing being displayed. As the set of descriptors associated to the displayed data entity is also loaded, the user may execute said descriptors while the data entity to which the descriptors are associated is displayed (as explained later via examples) or observe automatic execution for descriptors whose loading and execution are confounded.

In parallel to step S30 of displaying a data entity and loading the set of descriptors associated to the displayed data entity, the method comprises a step (S40) of performing an action on a “window” of results around the displayed data entity. Specifically, for each data entity of a subset of consecutive data entities of the received list of data entities surrounding the displayed data entity, the method comprises pre-loading (S40) the associated set of descriptors. The “window” is thus said subset, that is, a part of the data entities of the received list of data entities (i.e. the data entities returned at step S20) that surround the displayed data entity. Indeed, as the list has an order, it is possible to refer to consecutive data entities of the list “surrounding” the displayed data entity (e.g. a certain number of data entities ordered immediately before the displayed data entity in addition to a certain number of data entities ordered immediately after the displayed data entity, with the exception that the displayed data entity forms a hole in said subset of consecutive data entities). Of course, if the displayed data entity is the first (respectively, the last) data entity of the received list, the subset may only comprise data entities following (respectively, preceding) the displayed data entity. Alternatively, the list may be circular, so that the first data entity in fact virtually follows the last data entity. This is only a matter of implementation. The term “surrounding” here covers all the cases.

The number of consecutive data entities of the subset may be predetermined (or fixed), possibly adjusted by the user or automatically adjusted by the client computer system and/or the server. For example, the number of consecutive data entities of the subset may be selected as a compromise between fluidity of the system (thus taking into account performance limits of the system) and efficiency from the user point of view. Because the pre-loading S40 may be performed strictly simultaneously to the displaying S30, it is possible that the pre-loading S40 is interrupted before the predetermined number is reached, for example if the displaying is interrupted. Alternatively, the number of consecutive data entities of the subset may be undetermined, the method continuing to perform the pre-loading S40 and thereby to “increase” the subset as long as the displaying S30 is performed, possibly with a ceiling number related to the memory capacities of the system. Also, although it will be referred in the following to “one” subset for the sake of convenience, different subsets may be defined for the displayed data entity, with a different number of consecutive data entities within them. This may lead to a plurality of numbers of descriptors associated to data entities surrounding the displayed data entity being pre-loaded, depending on the descriptors (in other words, the method may pre-load the descriptors of different numbers of surrounding data entities, according to the nature of said descriptors). As can be appreciated by the one skilled in the art, issues related to the size of the subset and to how to handle concomitance between the displaying S30 and the pre-loading S40 may depend on choices of implementation of the method, or on memory and/or performance characteristics of the client system.

Pre-loading the set of descriptors for each data entity of the subset may be performed successively as distance from the displayed data entity increases. This ensures that data entities most likely to be selected next have their associated sets of descriptors pre-loaded faster. In other words, while the “displayed data entity” is effectively displayed at S30, the method performs the pre-loading S40 by taking into account an order between the data entities of the subset. Namely, for pre-loading the associated set of descriptors, the method starts with the data entities adjacent (with the lowest distance) to the currently displayed data entity (e.g. the data entity right before the displayed data entity and the data entity right after the displayed data entity, according to the order defined by the received list of data entities). Then, the method pre-loads the sets of descriptors associated to data entities adjacent to the data entities handled previously (as can be seen, distance increases compared to the previous pre-loading). This is iterated. Of course, the example discussed here implies the consideration of two data entities at a time, but the method may involve different paths for the iterating, possibly involving the handling of strictly more than two data entities at a step. Also, the case of the displayed data entity being at an extremity of the list is handled without any difficulty as previously discussed.

Thanks to the method providing that, when displaying a data entity, a set of descriptors associated to said displayed data entity is loaded, it is ensured that the user may acquire more information on the data entity than the mere display of the data entity, that is, by executing said descriptors upon such request. Thanks to the pre-loading of the descriptors associated to other data entities substantially at the same time (i.e. in parallel), the method ensures fluidity and prepares for the user requiring to display another one of the data entities of the received list that is in the subset. Indeed, if the user selects a data entity belonging to the subset, as its associated set of descriptors is already pre-loaded, the loading of said associated set of descriptors will be performed smoothly and fast when the newly selected data entity is displayed. The method thus manages hardware resources in an efficient way and anticipates user actions.

Indeed, the method may further comprise a user request for performing further actions. The user request may notably trigger the display of another one of the data entities of the received list of data entities (e.g. a data entity belonging to the subset). As a consequence, the method may comprise automatically loading the set of descriptors associated to the data entity that is newly displayed. Furthermore, to keep the benefits of having a “window” of data entities for which the associated set of descriptors is pre-loaded, the method may comprise, in this example, for each data entity of a new subset of consecutive data entities of the received list of data entities, pre-loading the associated set of descriptors. The “new subset” surrounds the newly displayed data entity, as the previous subset surrounded the previously displayed data entity. The “new subset” may be defined so as to have a number of data entities equal to the predetermined number (mentioned above), if any, and/or so as to ensure that the position of the newly displayed data entity in the new subset is the same as the position of the previously displayed data entity in its surrounding subset (e.g. if such position is predetermined). In other words, at any time of the method, the displayed data entity may be at a fixed position relative to a (possibly variable) subset of data entities (i.e. a subset of the list of all the data respecting the query sent at S10 and received at S20) for which the associated descriptors are pre-loaded. Yet in other words, the “window” is updated any time the user requests displaying a new data entity of the received list, according to the position of the newly displayed data entity.

In particular, the user request may be a request to scroll the received list of data entities. As the received list is ordered, it is possible for the user to scroll forward or backward the received list so as to modify the displayed data entity. At each request to scroll forward or backward, the set of descriptors associated to the newly displayed data entity is already pre-loaded (because it belongs to the subset, as said subset surrounds at each time the currently displayed data entity). Therefore, the loading of said descriptors is performed fast.

Notably, pre-loading a descriptor may comprise receiving, on the memory of the client computer system, information for loading the descriptor. Said information may be retrieved by sending a request to at least one distant server, possibly including the same server that contains the dataset. Once a descriptor is pre-loaded, its loading may be performed fully locally. For example, loading the descriptor may comprise displaying an element based on said received information. For example, if the information contains text or image data, loading the descriptor may comprise displaying said text or image, the element thus being said text or image. In that case, if the descriptor consists of such text or image, loading the descriptor is confounded with executing the descriptor. Alternatively or additionally, loading the descriptor may comprise making available the element for immediate display upon user request (e.g. by clicking on a dedicated icon or displayed item). Here, the execution (i.e. the display) is well separated from the loading (i.e. the preparation for the display). Generalizing the latter example, loading the descriptor may comprise making available for immediate execution upon user request (e.g. by clicking on a dedicated icon or displayed item), an element determined based on said received information. In that latter example, the element may be anything, notably an application or an audio track instead of a displayable element. Execution of the descriptor may thus comprise running the application or playing the audio track. The element is thus, in general, any type of executable data determined based on the downloaded information.

To summarize, the whole process for describing a displayed data entity with a descriptor comprises pre-loading the descriptor, then loading the descriptor, and then executing the descriptor. Possibly, as explained above, the loading may be confounded with the execution. In any case, the part of this process that usually takes most time is the pre-loading, as it involves sending a request to a distant server and receiving information from the server, whereas the other parts are performed fully locally. As a consequence, by pre-loading the descriptors which are likely to be loaded next e.g. by the scrolling, the method enhances user experience and productivity by avoiding the delay necessary to the pre-loading when e.g. the scrolling is performed. When a data entity is displayed, its associated descriptors are already pre-loaded and can thus be executed fast, as the method provides that they are loaded. Meanwhile, the descriptors of other data entities are pre-loaded (these other data entities are the ones that belong to the new subset, i.e. the subset corresponding to the displayed data entity, that were not in the subset corresponding to the previously displayed data entity). Thus, if the user decides to display another data entity again, e.g. by performing another scroll, then the associated descriptors will be available for fast loading (as they are pre-loaded).

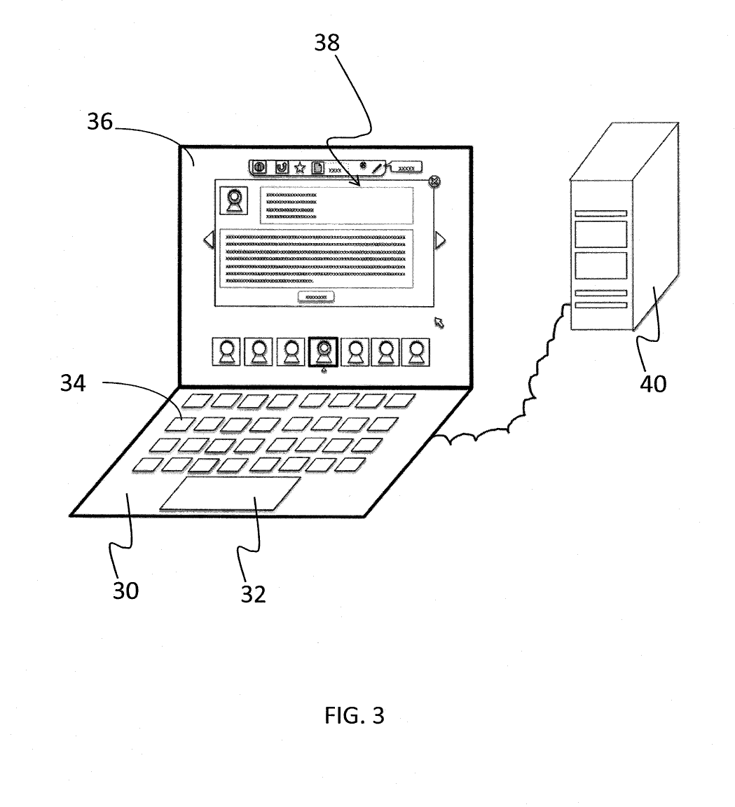

Optional functionalities of the method and client system will now be discussed with reference to FIGS. 3-7, which show an example of performing the method with a client computer system. In the example, the user is a head hunter, or any professional whose duty includes identifying, sorting and/or screening people profiles, and processes a database of data entities that are people profiles. However, the following discussion applies to other applications of the method where the data entities may represent other things. The head hunter may have the goal of looking through the people profiles and performing a fast and rough overview and/or pre-selection of all profiles that correspond to some criteria. The dataset can be quite large. The example highlights the benefits of the method which allows such data processing in a fast way.

FIG. 3 shows an example of a client computer system 30 while performing said example of the method. Client computer system 30 is a laptop and may have the same architecture as system 10 of FIG. 1. Client computer system 30 notably comprises a memory which is not represented, a graphical user interface that includes touchpad 32, keyboard 34, screen 36, and an application interface 38 represented as a screenshot on screen 36. Client computer system 30 also comprises a processor coupled to the memory and to the graphical user interface, and operable to implement instructions recorded on another memory for performing the method. For that, client computer system 30 is connected to a distant server 40, as schematically represented on the figure. Client computer system 30 may be connected to server 40 via an internet connection. In this case, the access to the server to perform client-server communication steps of the method (including the sending (S10) and the receiving (S20) steps) may be performed via a web browser. Thus, the received list of data entities (received at step S20) may be stored on a memory used by such web browser.

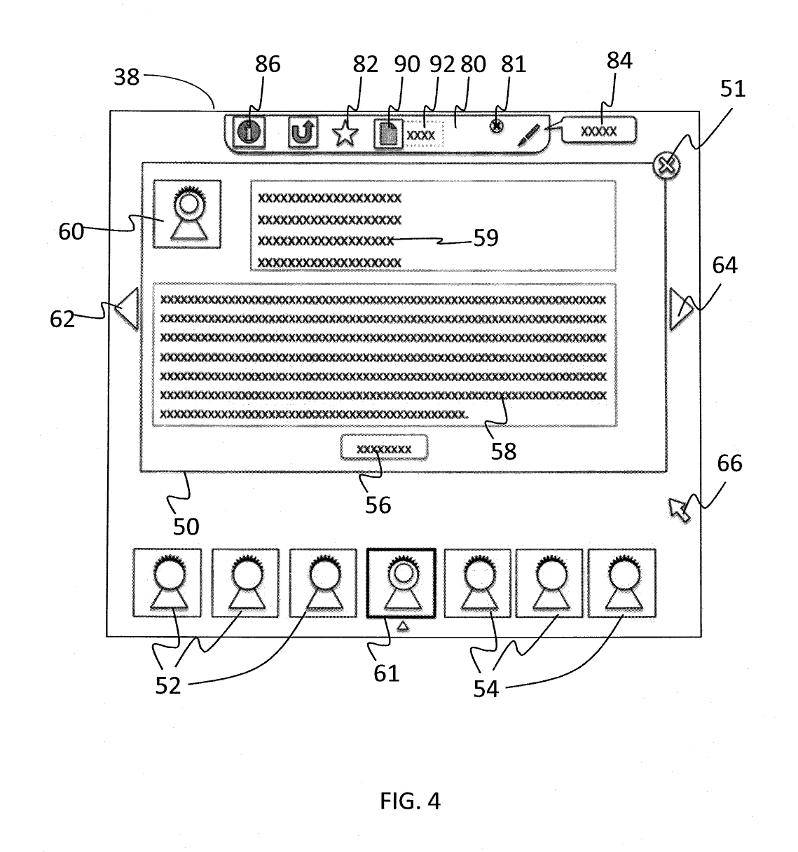

FIGS. 4-7 show application interface captions 38 displayed on the screen of client computer system 30 while the head hunter performs the method with different options. The application interface captions 38 correspond to what is seen by the head hunter when running the application with system 30 to perform the method, e.g. with a web browser.

It is now referred to FIG. 4, which illustrates the displaying S30 of a people profile in a frame 50 (reference 50 also designating said people profile in the latter, for the sake of convenience), which is one data entity of the received list of data entities.

The received list of data entities is not displayed. However, the view of FIG. 4 may result from optional prior steps of the method. For example, the method may further comprise, prior to the displaying S30 of data entity 50 of the received list, displaying previews of a sub-list of the received list, and, upon user request, selecting one of the displayed previews, thereby defining the data entity of the received list to be displayed. In other words, after receiving S20 the list of data entities of the dataset respecting the search query, the method may display a sub-list (i.e. a subset keeping the order) of the list returned at S20. This is well known from the field of search engines. This may be for example, first, the first N people profiles of the list, where N is any number, e.g. adapted to the size of the screen or the web browser. The user may then scroll to other sub-lists, consisting of people profiles from people profile ordered k*N+1 until people profile ordered (k+1)*N, k varying so that such sub-lists cover the whole list, as known per se. In any case, the people profiles of each sub-list may be displayed as previews. In other words, only a summary of the data constituting the people profiles is displayed (thus, less matter is displayed in a preview that when the data entity is displayed at S30). Steps S30 and S40 are then activated by selecting one of the previews, e.g. by clicking on it or on a link embedded within it. This launches flame 50, within which the selected profile is displayed. In other words, people profile 50 is displayed at S30 and is the people profile of whose preview was selected. It is noted that, in the example, it is possible to return to the view showing previews of sub-lists (which may remain faded as a background when the view of frame 50 is activated) by clicking on closing icon 51 of frame 50.

The method of the example determines the six consecutive people profiles of the received list that surround displayed people profile 50. The case of people profile 50 not being surrounded by enough people profiles on one hand is handled in any way by the implementation, as discussed earlier. The method then pre-loads the associated set of descriptors for the people profiles of the subset. More generally, the number of people profiles of the subset is superior to two.

Displaying S30 people profile 50 may comprise displaying within frame 50 text determining key information 59 on the person whose profile people profile 50 is (e.g. name, current profession, highest degree), text providing the resume and/or academic background 58 of the person, a link 56 to a (e.g. personal) website of the person, and a picture 60 of the person. Any additional and relevant information constituting the people profile may be displayed within frame 50.

In the case of the example, the method further comprises, simultaneously to the displaying S30 of people profile 50 of the received list, displaying a preview (52, 54) of at least some of the data entities of the subset (or at least a part of them), said data entities being not (entirely) displayed. (References 52 and 54 also apply to the data entities themselves for the following, for the sake of convenience.) In other words, some of the people profiles of the subset, i.e. the ones for which the associated sets of descriptors are pre-loaded at S40, preferably those that are the closest to currently displayed profile 50, are shown to the user by displaying their previews (52, 54). In the example, the previews (52, 54) consist of a picture of the people profiles. The previews (52, 54) have the same size of picture 60 in the example, but they could similarly be of smaller size for the sake of taking less space on the screen. Also, the previews (52, 54) form a strip organized according to the order of the received list, i.e. the order between the people profiles of the subset. As can be seen on FIG. 4, displayed user profile 50 has also its preview 61 displayed within the strip. Said preview 61 has the same format as the other previews 52 or 54, that is to say, a picture format, but it is highlighted in order to show to the user that profile 50 currently displayed is the one corresponding to preview 61. As can be noticed, displayed data entity 50 is here at a central position in the subset. Indeed, the people profiles 52 and 54 of the subset are arranged symmetrically on each side of profile 50 within the list of results respecting the query (three on each side). This way, the method equally anticipates the will of the user to either go forward or backward within the list. However, the arrangement could as well be asymmetric. Furthermore, the special case of the displayed people profile 50 being among the first results of the received list or the last results of the list, and thus not being able to be at a central position in the subset can be handled in any way contemplated by the one skilled in the art.

As discussed above, the application provides for displaying another one of the people profiles of the subset. This may be performed by selecting a people profile of the subset, for example by acting (e.g. clicking or touching) on any preview 52 or 54. As mentioned earlier, this can alternatively be performed by scrolling the received list of data entities, for example by activating (e.g. clicking or touching) displayed arrow 62 or 64, or, alternatively, by using keyboard arrow buttons or other dedicated buttons, or by performing a sweeping move with at least one finger on a touchpad or a sensitive screen in the case of systems having such material. In other words, the user may activate the displaying of the people profile and the loading of its associated set of descriptors by going to a neighboring people profile (i.e. the next ordered people profile, e.g. with arrow 64, or the previous ordered people profile, e.g. with arrow 62) and repeat such action. In both cases, as the new people profile belongs to the subset, the associated set of is already pre-loaded, and thus will be loaded fast upon display of said new people profile. Also, the strip mentioned earlier will be updated, as the surrounding subset is updated.

In the case of the scrolling, the repetition can be such that more than twenty (or fifty, or even a hundred of) people profiles are scrolled, e.g. in less than 5 minutes, preferably in 1 minute. In other words, the user makes the method repeat step S30 (and thus S40) more than a twenty times. This is notably characteristic of head hunting. Indeed, a head hunter performing the method typically enters a rough search query at S10 for finding people potentially adequate for a job position, which results in the list of data entities received at S20 being quite large, typically higher than twenty (or fifty, or even a hundred of) user profiles. Then, the head hunter typically scrolls the user profiles of the list one by one as a first screening, in order to overview the list (which constitutes a rough result) and/or perform a pre-selection. The pre-selection may consist in the method comprising, upon user action, modifying at least one of the set of descriptors associated to the displayed data entity. In other words, the head hunter may modify one or several of the descriptors to people profile 50 that is displayed at some point. Later, when displaying again the same people profile, for example during a second screening, the head hunter may recognize a user profile according to its associated descriptors, including the modifications brought to the descriptors. Specific examples of the nature of the descriptors will however be provided later. Now, because the descriptors associated to the next people profile (i.e. the profile to be displayed next) are pre-loaded before the head hunter scrolls from the current people profile to the next people profile, there is no delay for loading the associated descriptors (notably, the delay necessary to send a request to the server to receive, on the memory of the client computer system, information for loading the descriptors). The scrolling may thus be performed smoothly.

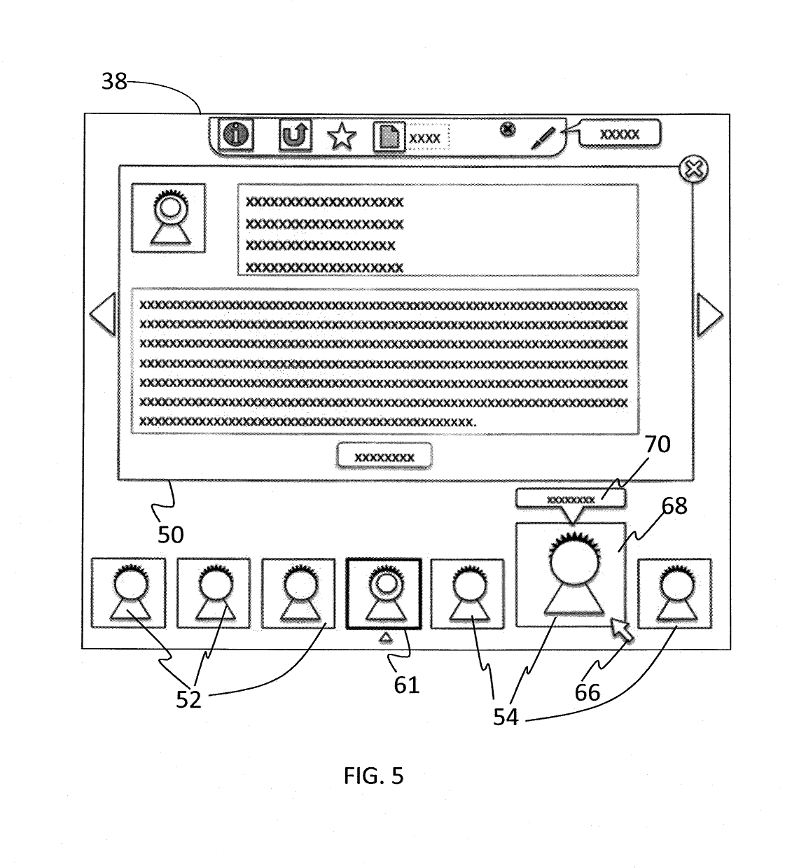

But, for the sake of the application being more convenient, and as already discussed, the head hunter may also display another people profile than profile 50 by selecting a people profile of the subset, thus a people profile corresponding to any of previews 52 or 54. FIG. 4 shows the displaying S30 with cursor 66 of the haptic device of the system not activating any displayed element. FIG. 5 represents moving cursor 66 on a user profile 68 of group of previews 54 of user profiles belonging to the subset, e.g. before selection of user profile 68 (e.g. by a click). In the example, this enlarges the preview of user profile 68, and also launches the display of text 70, for example containing the name of user profile 68. This helps the head hunter decide whether or not it is useful to display user profile 68 in the extended view, that is, as currently displayed user profile 50.

Example descriptors of the example of FIGS. 3-7 are now discussed.

The example descriptors of the example are linked to toolbar 80. Specifically, example descriptors include an element (e.g. information) displayed in toolbar 80 or in a way as to be linked to toolbar 80, or an element (e.g. information) displayable in toolbar 80 or in a way as to be linked to toolbar 80 upon activating (e.g. by clicking or touching, and/or moving on) an icon displayed in toolbar 80. It is also noted that toolbar 80 may be closed by the user by activating toolbar closing icon 81.

The set of descriptors may comprise at least one descriptor of a previous use of the dataset. In other words, the system can keep track of what the user has performed before. For example, if a particular people profile has been viewed by the head hunter in a previous use of the application, this can be remembered by the system. The information can then be sent to a server. Then, when the head hunter displays S30 the same people profile again, the information that the people profile was already e.g. viewed (or selected, or contacted) previously can be displayed. Pre-loading of such a descriptor comprises downloading the information from the server, while loading such descriptor consists of making the information available for display, possibly automatically when the associated data entity is displayed other words, the execution may be automatically comprised in the loading).

Referring to FIG. 4, this can for example be done by marker 82 being fully colored or not (full color meaning that currently displayed people profile 50 has already been viewed before). Of course, alternatively or additionally, marker 82 may be manually color filled by the user, e.g. by activating marker 82 for changing its state from filled to unfilled and vice-versa. The head hunter may this way mark people profile 50 to associate to it a binary information (alternatively, possibly representing anything else).

In the following, the expression “respective entity” designates the data entity to which a descriptor under study is associated. As it will be referred to the figures, the respective entity is for the sake of the discussion user profile 50.

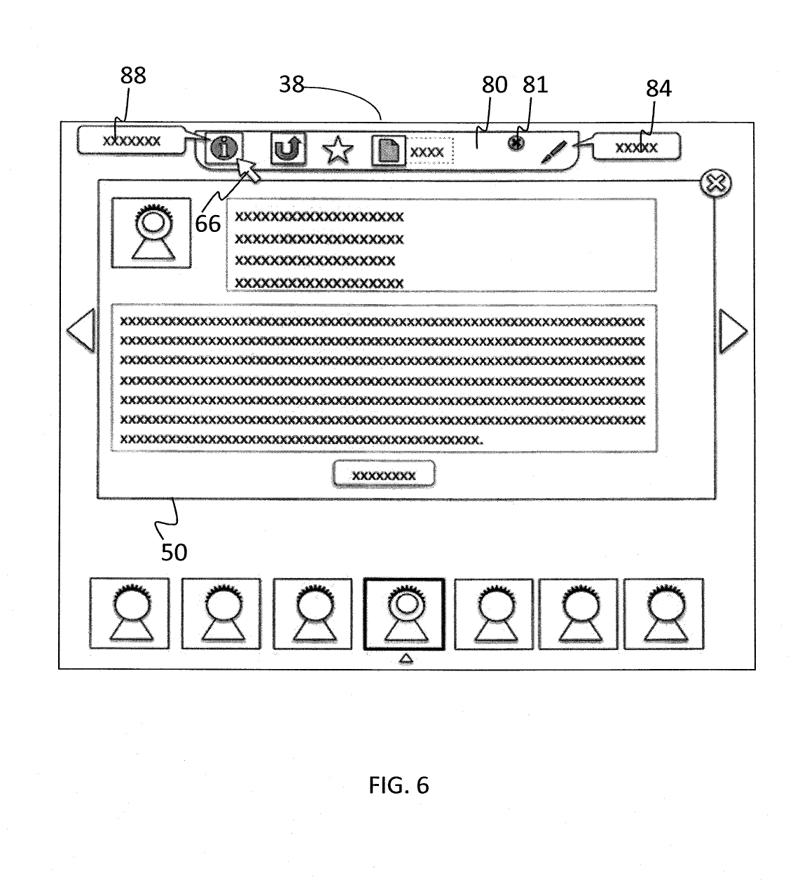

The set of descriptors may also comprise a comment (e.g. text) previously written (e.g. by the head hunter) for the respective entity. The pre-loading of such a descriptor comprises retrieving such comment from a server, and the execution of such descriptor comprises displaying such comment. Referring to FIG. 4, the comment may be as text 84 displayed in parallel to the displaying S30 of data entity 50. In other words, as soon as people profile 50 is displayed, text 84 is displayed. The execution of such descriptor is thus confounded with (or comprised in) the loading. Referring to FIGS. 4 and 6, the comment may be alternatively text 88 displayed upon activating icon 86, for example by moving cursor 66 on icon 86. In other words, loading text 88 consists of making text 88 available for display upon user request (which corresponds to execution of said descriptor).

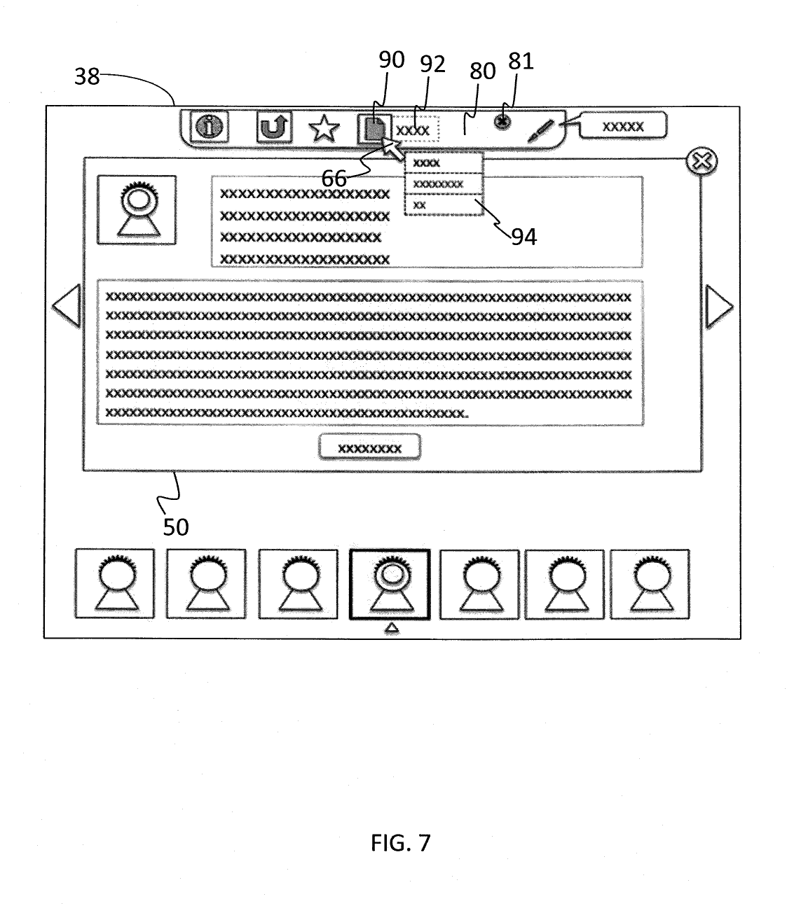

Referring to FIGS. 4 and 7, toolbar 80 further comprises tool 90 for sorting the displayed data entity in a filetree. The filetree may be any tree organizing folders to which the people profiles may be associated. This way, the head hunter can organize/sort the people profiles browsed. In a simple to apprehend implementation, the filetree may simply consist of a set (e.g. a list) of folders. Specifically, tool 90 may be associated to descriptor 92 which is a text indicating a position of the respective data entity (user profile 50 in the present case) in the filetree (possibly void if the respective data entity is not associated to any folder yet). The pre-loading of descriptor 92 may consist of downloading such text or downloading information relative to the folder to which user profile 50 is associated. Executing descriptor 92 consists of displaying the text. Now, by activating icon 90, for example by moving cursor 66 on it and clicking on it, as shown on FIG. 7, the system may display a representation 94 of the filetree showing all folders. The head hunter may then modify descriptor 92 by selecting one folder shown in representation 94. This sorting system saves extra steps for the user, by providing a direct way to sort profiles into folders directly from the toolbar.

Thus, the system allows the access to distant data entities (user profiles in the case of the example), scroll and display the data entities together with descriptors, the descriptors possibly allowing the marking/annotating/sorting of the data entities so that the user (typically a head hunter in the case of the example) may screen the received list fast for a first round, and then, in later rounds, concentrate, possibly using the same system, on data entities which have retained his/her attention and thus for which he/she has modified at least one descriptor. Notably in head hunting, the scrolling of the first can be very fast, which makes the fact that the descriptors of the next to be displayed entity are already pre-loaded when said data entity is actually displayed particularly efficient for the method.

Furthermore, as discussed above and as it is the case for the example descriptors provided, it is noted that the pre-loading may comprise downloading information on the data entities of the subset surrounding the currently displayed data entity. Once downloaded, the information may be kept in memory for the whole session, although a data entity once in the subset may be out of the subset when another data entity is displayed (since the subset moves as the displayed data entity moves along the received list of data entities respecting the query). This avoids making requests to a distant server if the data entity in question is later once again in the subset under consideration. In such case, the pre-loading consists of retrieving such previously kept information and is thus performed locally. However, notably for descriptors which are heavy for the web browser to handle, such as, for example, embedded web frames, at least a part of the information may be erased once the data entity in question is out of the subset.

I claim:

1. A method, implemented with a client computer system connected to a server and having a processor coupled to a memory and a graphical user interface, the method being for processing a dataset of data entities stored on the server and each associated to a set of descriptors, and the method comprising:
sending, to the server, a search query inputted with the graphical user interface,
receiving on the memory of the client computer system, from the server, a list of data entities of the dataset respecting the search query,
displaying a data entity of the received list of data entities, and loading the set of descriptors associated to the displayed data entity, and,
for each data entity of a subset of consecutive data entities of the received list of data entities surrounding the displayed data entity, pre-loading the associated set of descriptors.

2. The method of claim 1, wherein pre-loading a descriptor comprises receiving, on the memory of the client computer system, information for loading the descriptor.

3. The method of claim 2, wherein loading the descriptor comprises displaying, or making available for immediate display upon user request, or making available for immediate execution upon user request, an element determined based on said received information.

4. The method of claim 1, wherein pre-loading the set of descriptors for each data entity of the subset is performed successively as distance from the displayed data entity increases.

5. The method of claim 1, wherein the method further comprises, upon user action, modifying at least one of the set of descriptors associated to the displayed data entity.

6. The method of claim 1, wherein the method further comprises, upon a user request:
displaying a new data entity of the received list of data entities, and loading the set of descriptors associated to the newly displayed data entity, and
for each of a new subset of consecutive data entities of the received list of data entities surrounding the newly displayed data entity, pre-loading the associated set of descriptors.

7. The method of claim 6, wherein the user request is a request to scroll the received list of data entities.

8. The method of claim 7, wherein the request to scroll the received list of data entities is repeated, so as to scroll more than twenty data entities.

9. The method of claim 1, wherein the displayed data entity is at a central position in the subset.

10. The method of claim 1, wherein the set of descriptors comprises at least one descriptor of a previous use of the dataset.

11. The method of claim 1, wherein the set of descriptors comprises any one or several of the following:
a binary information on the associated data entity,
a position of the respective data entity in a filetree, and/or
a comment previously written for the respective entity.

12. The method of claim 1, wherein loading a descriptor comprises displaying, or making available for immediate display upon user request, an element linked to a toolbar.

13. The method of claim 12, wherein the toolbar further comprises a tool for sorting the displayed data entity in a filetree.

14. The method of claim 1, wherein the method further comprises, simultaneously to displaying a data entity of the received list, displaying a preview of the data entities of the subset that are not displayed.

15. The method of claim 1, wherein the method further comprises, prior to displaying a data entity of the received list:
displaying previews of a sub-list of the received list,
upon user request, selecting one of the displayed previews, thereby defining the data entity of the received list to be displayed.

17. The method of claim 1, wherein the client computer system is connected to the server via an internet connection, the received list of data entities being stored on a memory used by a web browser.

18. The method of claim 1, wherein the data entities are people profiles.

19. A client computer system comprising:
a memory,
a graphical user interface, and
a processor coupled to the memory and the graphical interface, and operable to implement instructions recorded on another memory for performing a method for processing a dataset of data entities stored on a server and each associated to a set of descriptors, and the method comprising:
sending, to the server, a search query inputted with the graphical user interface,
receiving on the memory of the client computer system, from the server, a list of data entities of the dataset respecting the search query,
displaying a data entity of the received list of data entities, and loading the set of descriptors associated to the displayed data entity, and,
for each data entity of a subset of consecutive data entities of the received list of data entities surrounding the displayed data entity, pre-loading the associated set of descriptors.

20. A computer program product, comprising instructions implementable by a client computer system connected to a server and having a processor coupled to a memory and a graphical user interface, the instructions being for implementing a method for processing a dataset of data entities stored on a server and each associated to a set of descriptors, and the method comprising:
sending, to the server, a search query inputted with the graphical user interface,
receiving on the memory of the client computer system, from the server, a list of data entities of the dataset respecting the search query,
displaying a data entity of the received list of data entities, and loading the set of descriptors associated to the displayed data entity, and,
for each data entity of a subset of consecutive data entities of the received list of data entities surrounding the displayed data entity, pre-loading the associated set of descriptors.

21. The computer program product of claim 20, further comprising a data storage medium having recorded thereon the instructions.
